(19) United States
(12) Patent Application Publication
(10) Pub. No.: US 2009/0213345 A1
(43) Pub. Date: Aug. 27, 2009

(54) Microlithography exposure apparatus using polarized light and microlithography projection system having concave primary and secondary mirrors

(76) Inventor: Hans-Juergen Mann, Oberkochen (DE)

Correspondence Address: FISH & RICHARDSON PC, P.O. BOX 1022, MINNEAPOLIS, MN, 55440-1022, US

(21) Appl. No.: 11/919,858

(22) PCT Filed: Apr. 27, 2006
(86) PCT No.: PCT/EP2006/003900

§ 371 Date: Jan. 30, 2009

Related U.S. Application Data
(60) Provisional application No. 60/677,276, filed on May 3, 2005.

(51) Int. Cl. G03B 27/42; G03B 27/72

(52) U.S. Cl. 355/53; 355/71

(57) ABSTRACT

The present invention relates to a microlithography projection exposure apparatus for wavelengths ≦100 nm, in particular for EUV lithography using wavelengths <50 nm, preferably <20 nm having an illumination system which illuminates a field in an object plane using light of a defined polarization state and an objective which projects the field in the object plane into an image plane, the polarized light passing through the objective from the object plane to the image plane.

### CROSS-REFERENCE TO RELATED APPLICATIONS

This application claims benefit of U.S. provisional application 60/677,276filed May 3, 2005 in the US patent and trademark office. The content of U.S. provisional application 60/677,276 is incorporated herein in its entirety.

### BACKGROUND OF THE INVENTION

1. Field of the Invention

The present invention relates to a projection exposure apparatus or facility operating at wavelengths ≦100 nm, in particular a projection exposure apparatus for EUV lithography using wavelengths ≦20 nm and a microlithography projection system for projecting an object in an object plane in to an image in an image plane.

2. Description of Related Art

Lithography using wavelengths ≦100 nm, in particular EUV lithography using wavelengths in the range from 1 nm to 20 nm, has been discussed as a possible technology for projecting structures <130 nm, especially preferably <100 nm. The resolution of a lithographic system is described by the following equation:

$$RES = {k}_{1} ⋆ \frac{λ}{NA} ,$$

k₁ identifying a specific parameter of the lithography process, λ identifying the wavelength of the incident light, and NA identifying the image-side numerical aperture of the system.

In order to achieve the highest possible resolution, it is necessary for the system to have the largest possible image-side numerical aperture NA.

Microlithography projection systems having four mirrors, six mirrors, and even eight and more mirrors are discussed as projection systems for microlithography using short wavelengths smaller than 100 nm, in particular smaller than 20 nm.

4-mirror projection systems for microlithography have become known, for example, from US 2003/0147130, US 2003/0147149, U.S. Pat. No. 6,213,610, or U.S. Pat. No. 6,302,548.

6-mirror projection systems for microlithography are disclosed in U.S. Pat. No. 6,353,470, U.S. Pat. No. 6,255,661, and US 2003/0147131.

8-mirror projection systems, which have more correction possibilities in relation to the above-mentioned 4-mirror projection systems and 6-mirror projection systems because of the manifold of optical surfaces, and therefore may correct the wavefront over a larger numeric aperture with sufficient precision for lithographic purposes, have become known from U.S. Pat. No. 6,710.917, U.S. Pat. No. 6,556,648, and U.S. Pat. No. 6,781,671, as well as US 2004/0189968.

The 8-mirror projection system according to US 2004/0189968 has the disadvantage that the chief ray angle of the central field point of the field to be imaged from the object plane in the image plane is >10° in the object plane. If reflective EUV masks in the object plane are used, large chief ray angles result in increased shadowing due to the absorber structures applied to the mask and therefore to increased CD variation over the field, i.e., linear structures of different orientation (e.g., horizontal and vertical structures) are imaged at different qualities, or have different resolution limits.

The reason for this high chief ray angle on the EUV mask in the 8-mirror projection system according to US 2004/0189968 is the convex surface of the first mirror in the light path from the object plane to the image plane and the concave surface of the second mirror of the projection system in the light path.

In the 8-mirror projection systems or so called 8-mirror projection objectives known from U.S. Pat. No. 6,556,648 and U.S. Pat. No. 6,781,671, the first mirror in the light path is a concave mirror and the second mirror in the light path is a convex mirror.

An embodiment of this type results in high angles of incidence on the second mirror in the light path and thus to increased aberrations, i.e., image errors. Furthermore, the reflectivity of the mirror is reduced.

A further disadvantage of the 8-mirror projection systems according to U.S. Pat. No. 6,781,671 and US 2004/0189968 are the relatively large absolute values of the radii of the first mirror. Mirrors having radii of this type may only be manufactured and measured with great difficulty. For example, radii measuring devices having a very long cavity are required for measuring mirrors of this type. The atmospheric interference (pressure and temperature changes) during the measuring process may corrupt the measurement result of the interferometric surface testing. In general, the atmospheric interference is less with a short cavity than with a long cavity.

### SUMMARY OF THE INVENTION

A problem in all microlithography projection systems having a very large image-side numerical aperture NA is that very high angles of incidence of the beams of the beam bundle, which passes in a light path through the microlithography projection objective from the object plane to the image plane, arise on some mirror surfaces of the mirror in the light path from the object plane to the image plane. For objectives having an image-side numerical aperture NA>0.3, these angles of incidence are more than 20° on certain mirrors.

With angles of incidence this high, the polarization properties of the light which is used for the projecting of the object-side structure onto the image-side structure comes into effect, since both the reflectivity and also the phase shift caused by the reflection differ for the different polarization states, namely s-polarization and p-polarization.

In order to overcome the disadvantages of the related art, according to a first aspect of the present invention, a microlithography projection exposure apparatus using wavelengths ≦100 nm, in particular in the range of EUV lithography using wavelengths ≦20 nm, comprises an illumination system which illuminates a field in an object plane using light of a defined polarization state. The polarized light reflected in the object plane reaches a projection system and projects the field illuminated in the object plane and the object situated in the object plane, e.g. a reticle or mask into an image plane. The polarized light passes in a light path through the projection system from the object plane to the image plane.

The projection system preferably has a image side numerical aperture NA≦0.3; preferably ≧0.35; more preferably ≧0.4; most preferably ≧0.45; more preferably ≧0.5.

The polarization state is preferably selected in such a way that the transmission of the projection system is maximized.

In an alternative embodiment of the present invention, the defined polarization state is selected in such way that essentially s-polarized light is provided on a mirror of the projection system having the greatest angle of incidence of a chief ray (CR) which originates from a central field point of a field in the object plane and is incident on that mirror. Essentially s-polarized in this application with regard to the mirror means that at least 90% of the light incident on the mirror surface of the mirror is s-polarized. The rest of the light incident on the mirror surface can be p-polarized or unpolarized.

In a preferred embodiment about 95% or more of the light incident on the mirror surface is s-polarized and in a most preferred embodiment about 98% or more of the light incident on the mirror surface is s-polarized.

In an alternative embodiment of the present invention, the defined polarization state is selected in such way that essentially s-polarized light is provided in the image plane.

Essentially s-polarized with regard to the image plane in this application means that at least 90% of the light incident on the image plane is s-polarized. The rest of the light incident on the image plane can be p-polarized or unpolarized.

In a preferred embodiment about 95% or more of the light incident on the image plane is s-polarized, in a most preferred embodiment about 98% or more of the light incident on the image plane is s-polarized.

In order to improve the projecting properties in projection systems having a great image side numerical aperture NA, in particular an image-side numerical aperture NA≧0.3, preferably >0.35, particularly preferably ≧0.4, particularly preferably ≧0.45, particularly preferably ≧0.5 and/or having mirrors on which the beams of the beam bundle which pass through the projection system from the object plane to the image plane are incident at high angles of incidence, the defined polarization state is selected e.g. such, that essentially s-polarized light is provided in the image plane.

By providing essentially s-polarized light in the image plane in which the light-sensitive substrate, such as the wafer, is situated, projecting at high quality is ensured even at great angles of incidence. S-polarized light is understood as light which is polarized tangentially in a particular plane, for example, in the image plane.

In a first embodiment of the present invention, the illumination system has a light source of a specific polarization state, such as a synchotron light source. S-polarized light is used as the preferred polarization.

In an alternative embodiment, it is also possible that the light of the light source emits unpolarized light. In a case of this type of light source, a polarization-optical element is installed in the illumination system, so that light with a defined polarization state illuminates the object in the object plane and reaches the projection system by reflection.

A defined polarization state may be set with the aid of a polarizer. For example, with the aid of the polarizer, the polarization state may be set in such way that the light in the plane of incidence is essentially s-polarized on the mirror which has the greatest angle of incidence of the chief ray in the entire projection system. Since the polarization is rotated upon each reflection on a mirror surface, different polarization states may exist on different mirror surfaces. Essentailly s-polarized in this application means that at least 90% of the light incident onto the mirror surface is s-polarized. The rest of the light incident on the mirror surface can be p-polarized or unpolarized.

In a preferred embodiment about 95% or more of the light incident on the mirror surface is s-polarized and in a most preferred embodiment about 98% or more of the light incident on the mirror surface is s-polarized.

Regarding providing light of a defined polarization state reference is made to US 2004/0184019 which disclosure content is fully enclosed in this application.

In a further preferred exemplary embodiment, the polarization state in the object plane may be selected such that the transmission of the objective or projection system is maximized. This may be performed with the aid of an algorithm, for example, which changes the polarization state in the object plane until the transmission by the projection system is maximized, i.e., the highest light intensity exists in the image plane of the projection system.

According to a second aspect of the present invention, a microlithography projection system is provided which is distinguished by a high aperture and avoids the disadvantages of the related art.

This second aspect is achieved for a microlithography projection system having at least preferably 8 mirrors in that in a microlithography system, the first mirror in a light path from a object plane to a image plane and also the second mirror in the light path has one of the following surfaces:
the first mirror has a concave surface and the second mirror has a planar surface or
the first mirror has a planar surface and the second mirror has a concave surface or
the first mirror and the second mirror both have a concave surface.

Furthermore, all nonplanar mirrors of the microlithography projection objective have a mirror radius which has an absolute value less than 5000 mm.

By the implementation of the first mirror in the light path from the object plane to the image plane as a concave mirror, even at an object-side aperture of NAO=0.125, a small chief ray angle occurs at the object in the object plane, which is preferably less than 7.5°. At chief ray angles less than 7.5° it is possible to illuminate the object in the object plane without shadows and also minimize the shadowing effect of reflecting object, in particular the reflecting EUV mask.

Small angles of incidence, in particular on the second mirror, are achieved in that the second mirror surface is a concave mirror. By the small angles of incidence on the second mirror, the phase and amplitude errors, which are preferably caused by the coating, are minimized.

By mirror radii which have absolute values less than 5000 mm for all mirrors of the microlithography projection system, the production of the mirrors is significantly simplified, in particular with regard to the radius measurement.

It is especially advantageous if the optical powers on the first two mirrors in the light path of the projection system from the object plane to the image plane are distributed uniformly. A measure of the distribution of the optical powers on the two mirrors is given by the quotient of the mirror radii

$$\frac{R 1}{R 2} .$$

A uniform distribution of the optical powers between the first mirror in the light path from the object plane to the image plane and the second mirror in the light path from the object plane to the image plane is preferably provided as defined in the present application when the condition

$$- 6 < \frac{R 1}{R2} < - \frac{1}{6}$$

is fullfiled.

The second mirror in the light path preferably has a greater radius than the first mirror.

This has the advantage that the aperture stop, which preferably comes to lie on the second mirror or in proximity to the second mirror in the present exemplary embodiments, does not necessarily have to be moved into the mirror when the numerical aperture is reduced or stopped down in order to avoid vignetting effects.

It is especially preferable if each of the used areas of the individual mirrors of the microlithography projection objective have a volume claim, which is also called a rear installation space, which has a sufficiently large depth, measured from the mirror front within the used area such that the mirrors have sufficient thickness and therefore stability. Furthermore the volume claim is such that the mirrors are easily accessible from outside the objective and may be mounted easily in mounts. A used area of a mirror is understood in the present application as the area of a mirror surface on to which the beams of a beam bundle which passes through the objective from the object side to the image side are incident.

The depth of the volume claim, which is also denoted as rear installation space, parallel to the optical axis, measured from the mirror front within this used area, is preferably greater than ⅓ of the value of the diameter of the particular mirror. Alternatively, in a preferred embodiment the depth of the volume claim is at least 50 mm.

In a further embodiment of the invention a microlithography projection system with at least eight mirrors is provided, wherein the projection system has an unobscured exit pupil, which is not vignetted and each mirror comprises a volume claim. The volume claim of each mirror does not penetrate one another and all volume claims can be expanded in at least one direction parallel to an axis of symmetry of the projection optical system without intersecting the light path in the projection optical system or the volume claim of any other mirror of the projection system.

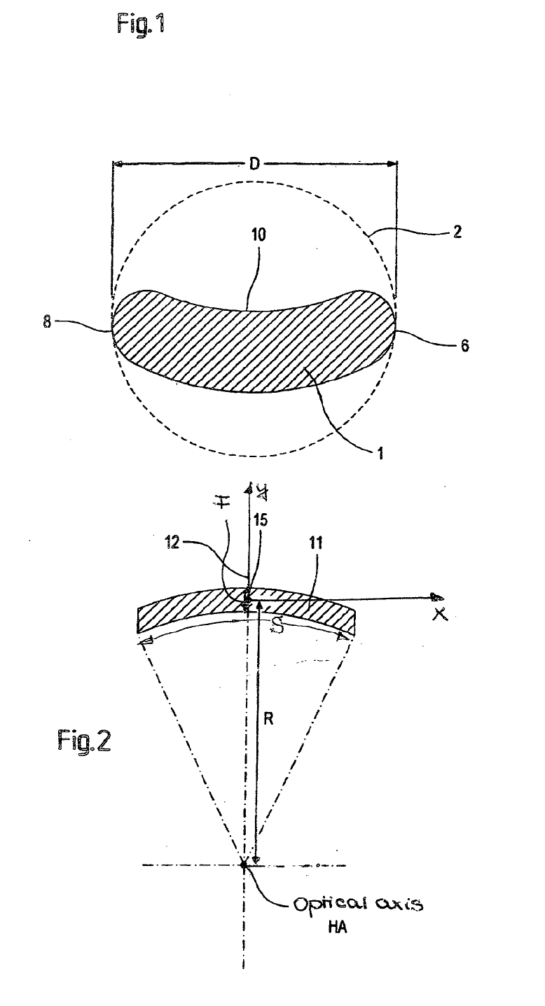

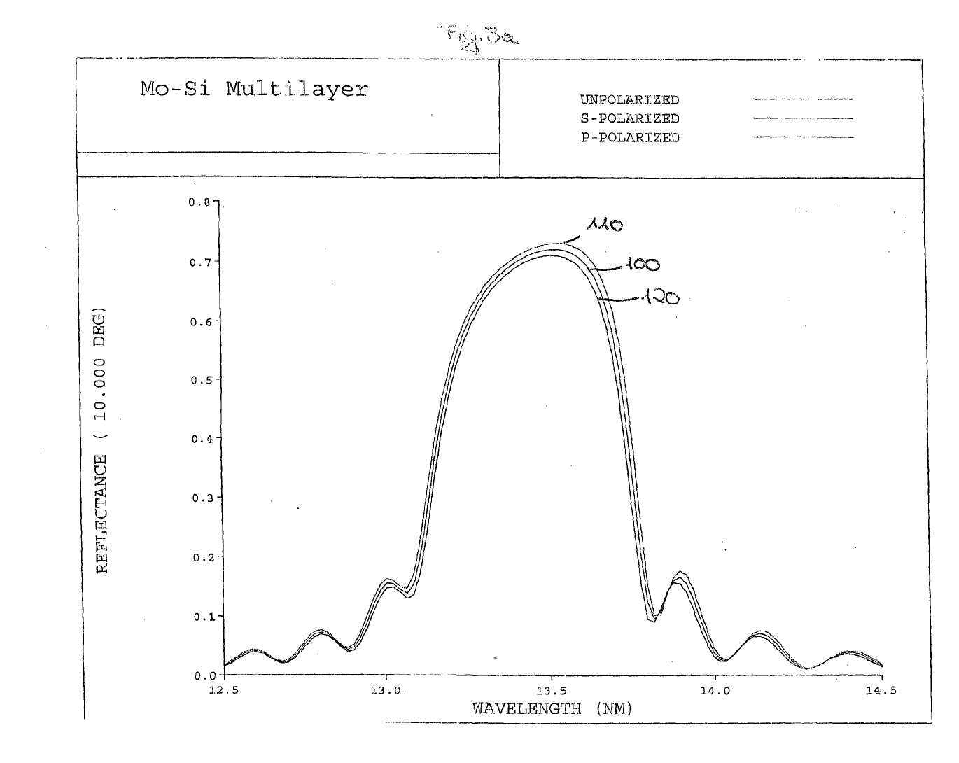

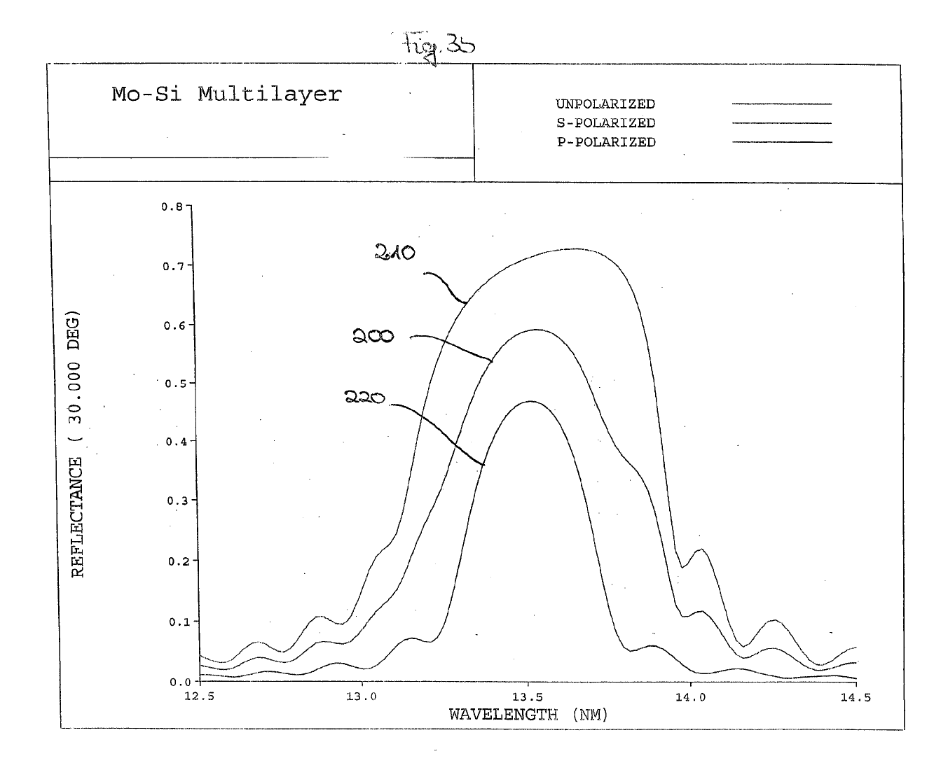

An axis of symmetry of the projection optical system is e.g. the axis of symmetry of an object field illuminated in the object plane as shown e.g. in FIG. 2 of this application. Preferably the axis of symmetry of the object field illuminated in the object plane is parallel to the y-direction of the field or the scanning direction. If the axis of symmetry is as described above the axis of symmetry of the object field then the volume claim can be extended according to the invention in a direction parallel to the y-direction.

The advantage of a projection optical system comprising at least eight mirrors with such an arrangement of the volume claims is, that the mirrors are easily accessible at least from one side. By this measurement the used areas of each mirror can easily mounted. Furthermore each of the mirrors can easily be changed, e.g. in case of contamination. Moreover lines could be easily mounted to each mirror, if e.g. the mirrors have to be cooled by cooling lines.

Since in a projection optical system having at least eight mirrors the light path of light propagating through a projection system has to be propagating not only in the direction from the object plane towards the image plane, but back and forward in order to provide a system with a reasonable track length, it is difficult and not trivial to find designs, in which the light path is not intersected by the volume claims of the mirrors, even if designs are known for six mirror system e.g. from U.S. Pat. No. 6,867,913. Furthermore in a projection optical system comprising at least eight mirrors there have to be provided two more light paths between two additional mirrors in comparison to a six mirror system as e.g. known from U.S. Pat. No. 6,867,913. The location of the two additional mirrors within the projection objective has to be choosen such, that the two more light pathes are not vignetted and furthermore these light pathes do not intersect any of the volume claims. This is a further problem which has to be overcome when finding a design for a projection system having at least eight mirrors, even if designs are known e.g. from six mirror systems.

The microlithography projection systems according to the present invention are preferably microlithography projection systems which have at least 8 mirrors. Preferably these projection system have an image-side aperture NA>0.30, preferably NA>0.35, preferably NA>0.4. The field width, i.e., the scanning slit length, is preferably more than 1 mm, preferably more than 1.5 mm and 2 mm, and very especially preferably more than 2 mm at the image side.

### DETAILED DESCRIPTION OF THE INVENTION

The present invention is now to be described generally in the following on the basis of the exemplary embodiments and the figures without restriction thereto.

FIG. 1 shows the definition of the used area or the so called useful area of a mirror

FIG. 2: shows the shape of the field in the object plane of the projection system

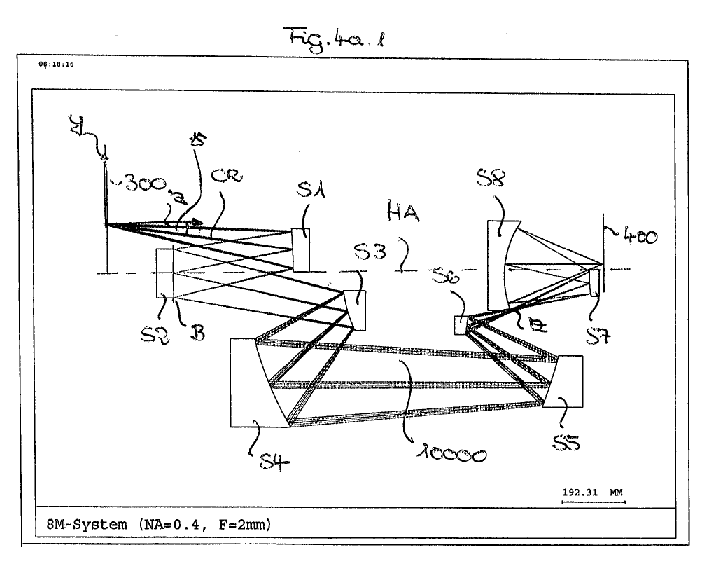

FIGS. 3a-b: show the reflection behavior of different polarization states at different angles of incidence

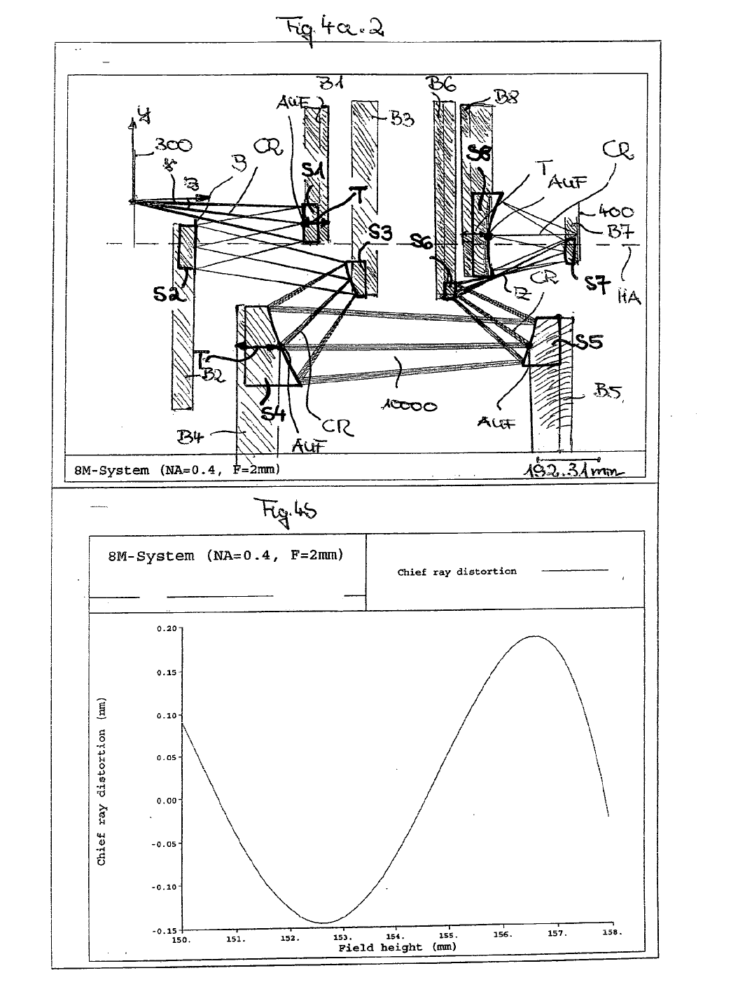

FIGS. 4a.1-b: show a first exemplary embodiment of a projection system according to the present invention having 8 used areas and a image-side numerical aperture NA=0.4 and a image side ring field size of 2×26 mm²

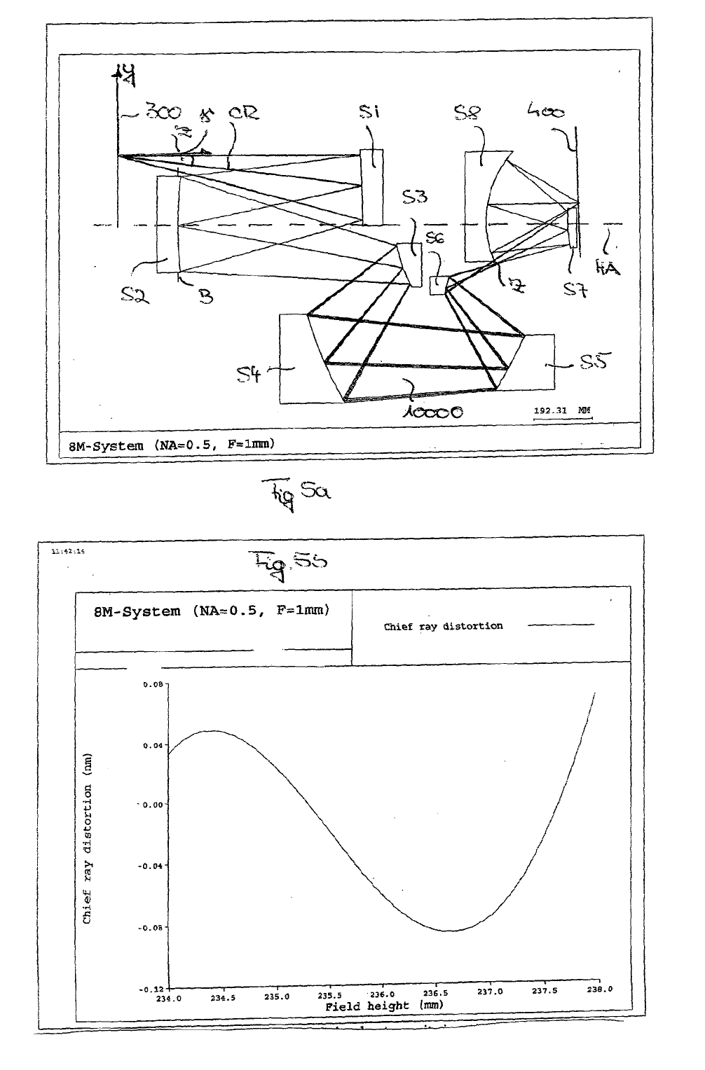

FIGS. 5a-b: show a second exemplary embodiment of a microlithography projection system having image-side numerical aperture NA=0.5 and a image side ring field size of 1×26 mm²

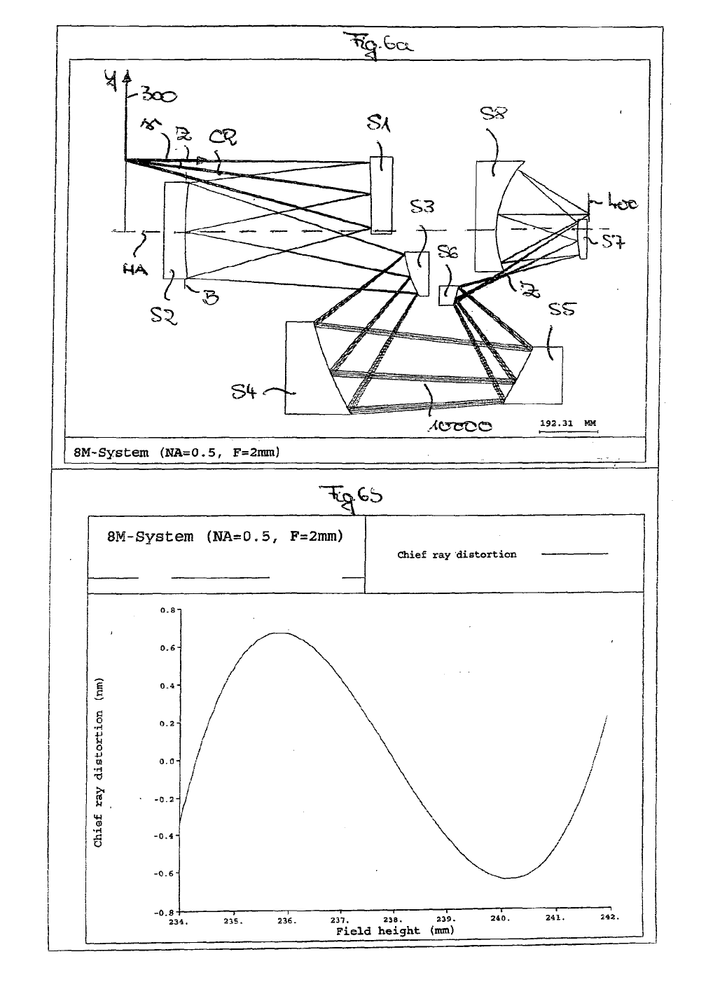

FIGS. 6a-b: show a third exemplary embodiment of an microlithography projection system, preferably for EUV microlithography according to the present invention having an image-side numerical aperture NA=0.5 and a image side ring field size of 2×26 mm²

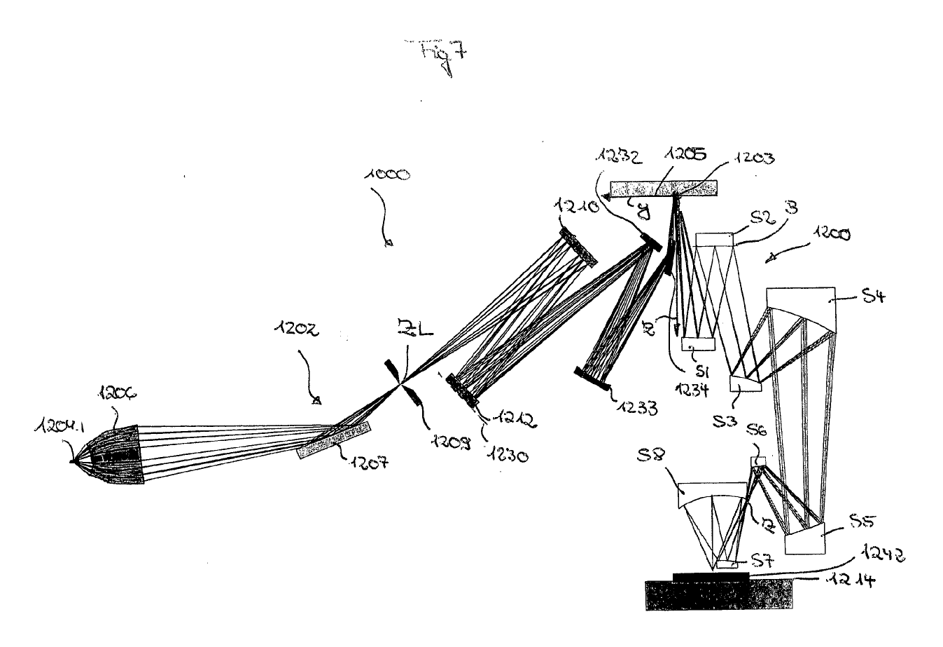

FIG. 7: shows a projection exposure apparatus comprising an illumination system and a microlithography projection system. The projection exposure apparatus preferably comprises a light source which emits polarized light.

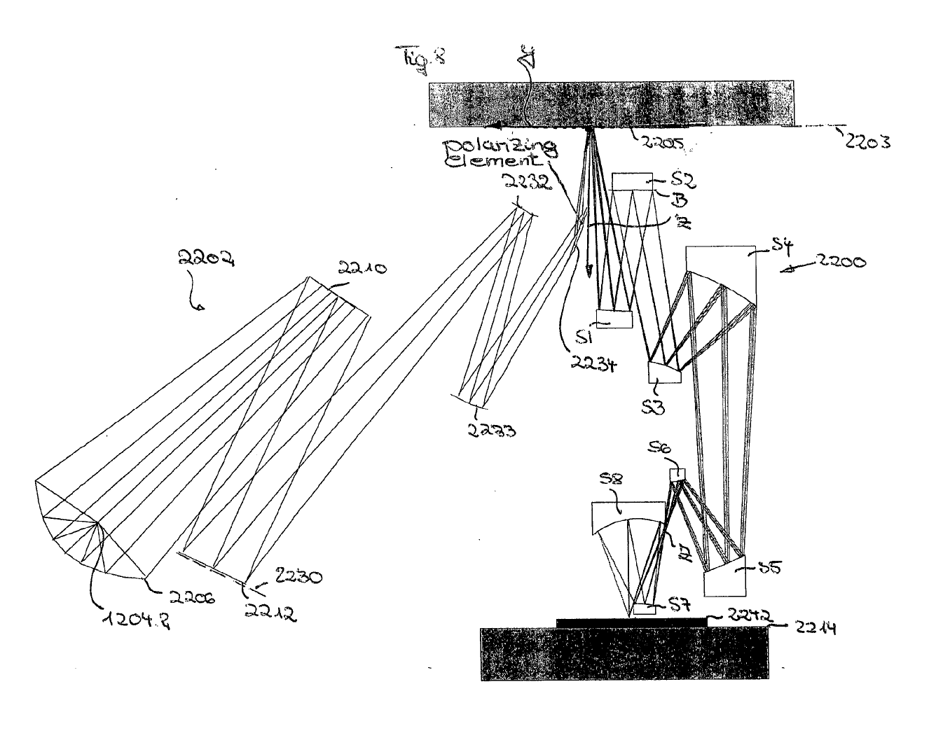

FIG. 8: shows a projection exposure apparatus comprising an illumination system and a microlithography system, in particular according to the present invention, having a light source which emits unpolarized light and an element for setting a polarization state.

FIG. 1 shows what is to be understood in the present application under a used area and diameter of a used area.

FIG. 1 shows, as an example of an illuminated area 1 on a mirror surface of a mirror of the projection objective, a field having a kidney shape. A shape of this type is expected for some of the used areas when the projection system according to the present invention is used in a microlithography projection exposure apparatus. The envelope circle 2 completely encloses the kidney shape and is coincident with the edge 10 of the kidney shape at two points 6, 8. The envelope circle is always the smallest circle which encloses the used area. The diameter D of the used area then results from the diameter of the envelope circle 2. The illuminated area on a mirror can have other shapes then the kidney shape, e.g. a circular shape, e. g. on the second mirror is also possible.

FIG. 2 illustrates for example the object field 11 of an EUV projection exposure apparatus in the object plane of the projection objective, which is imaged with the aid of the projection system according to the present invention in an image plane, in which a light-sensitive object, such as a wafer, is situated. The shape of the image field corresponds to that of the object field. With reduction projection systems, as are frequently used in microlithography, the image field is reduced by a predetermined factor in relation to the object field, for example by a factor of 4 for a 4:1—projection system or a factor of 5 for a 5:1—projection system For an EUV lithography system, the object field 11 has the form of a segment of a ring field.

The segment of the ring field 11 has an axis of symmetry 12. In a preferred embodiment of the invention the volume claim of each mirror can be expanded in a direction parallel to the axis of symmetry 12 of the object field as shown e.g. in FIG. 4a.2.

Furthermore, the x- and the y-axis of a x-,y-,z-coordinate system in the central field point 15 spanning the object plane and the image plane are shown in FIG. 2. As may be seen from FIG. 2, the axis of symmetry 12 of the ring field 11 runs in a direction parallel to the y-axis. At the same time, the y-axis is coincident with the scanning direction of an EUV projection exposure apparatus which is laid out as a ring field scanner. The y-direction is then coincident with the scanning direction of the ring field scanner. The x-direction is the direction which is perpendicular to the scanning direction within the object plane.

In FIG. 2, F identifies the width of the field, which is also referred to as the scanning slit width, S identifies the arc length, and R identifies the field radius. The image field which corresponds in its shape to the object field has a width F of the field in the image plane of preferably ≧1 mm, most preferably ≧2 mm. The arc length S in the image plane is preferably ≧10 mm, most preferably ≧26 mm.

In FIGS. 3a and 3b, the reflectivity of a Mo—Si multilayer system is shown. Such a multilayer system is used as a reflecting coating on the mirrors of the present projection objective for different angles of incidence.

Reference number 100 identifies the reflectivity of unpolarized light, reference number 110 identifies the reflectivity of s-polarized light, and reference number 120 identifies the reflectivity of p-polarized light. As may be seen, the reflectivities e.g. at the used wavelength of 13.5 nm currently used in EUV lithography differ only slightly at an angle of incidence of 10° on the reflecting surface.

FIG. 3b shows the reflectivity of an analogous layer structure to FIG. 3a, but optimized for an angle of incidence of 30°. The reflectivity for unpolarized light is identified by 200. The reflectivity for s-polarized light is identified by 210 and the reflectivity for p-polarized light is identified by 220. As may be seen from FIG. 3b, the reflectivity for p-polarized light is only approximately 0.45 at the used wavelength of 13.5 nm, while the reflectivity for s-polarized light has only fallen slightly and is approximately 70% corresponding to 0.7 even at an angle of incidence of 30° of light onto the reflective surface.

As may be seen from this, it is advantageous if essentially polarized light, particularly essentially s-polarized light, is used for the projecting of the reticle lying in the object plane into the image plane by the projection system.

Light having the used or operation wavelength of 13.5 nm, for example, is provided by the illumination system. The essentially s-polarized light may be generated in principle in two ways in the illumination system. In a first embodiment of the present invention, the illumination system comprises a light source which already emits s-polarized light, such as a synchotron radiation source. In an alternative embodiment, the illumination system comprises a light source which emits unpolarized light. The light is polarized within the illumination system with the aid of a polarizer, so that the reticle in the object plane is illuminated essentially with s-polarized light, for example.

In the following FIGS. 4a.1, 4a.2, 4b, 5a, 5b, 6a, 6b, three exemplary embodiments of microlithography projection systems according to the present invention are shown. The embodiments comprising eight mirrors and have an unobscured exit pupil. In the embodiments shown in FIG. 4a.1, 4a.2, 4b, 5a, 5b, 6a, 6b the first mirror and the second mirror in the light path from the object plane to the image plane are concave mirrors and the radii of all mirrors have an absolute value less than 5000 mm.

The data of the three exemplary embodiments shown in FIGS. 4a.1 through 6b are summarized in the following Table 1:

TABLE 1

| | Exemplary | Exemplary | Exemplary |
|---|---|---|---|
| | embodiment 1 | embodiment 2 | embodiment 3 |
| Wavelength | 13.5 | 13.5 | 13.5 |
| NA at the image | 0.4 | 0.5 | 0.5 |
| side | | | |
| Field at the image | 2 × 26 mm² | 1 × 26 mm² | 2 × 26 mm² |
| side | | | |
| Maximum field | 39.5 mm | 59.5 mm | 60.5 mm |
| radius at the image | | | |
| side | | | |
| Wavefront error | 6.1 mλ | 9.4 mλ | 15.4 mλ |
| (rms) | | | |
| Distortion | <0.2 nm | <0.1 nm | <0.7 nm |
| Chief ray angle at | 7.5° | 7.5° | 7.5° |
| the object | | | |

Exemplary embodiment 1 identifies the embodiment of a 8-mirror objective illustrated in FIGS. 4a. 1, 4a.2 and 4b, exemplary embodiment 2 identifies the embodiment illustrated in FIGS. 5a and 5b, and exemplary embodiment 3 identifies the embodiment illustrated in FIGS. 6a and 6b.

The wavelengths and the numerical aperture in the image plane, the field size in the image plane, the maximum field radius in the image plane, the wavefront error, the distortion, and the chief ray angle at the object, i.e., the reticle at the central field point, are specified in Table 1.

The first exemplary embodiment comprises, as shown in FIG. 4a.1, 4a.2, an object plane 300. An object in the object plane 300 is imaged with the aid of the projection system according to the present invention in the image plane 400. Proceeding from the object, a light bundle passes through the microlithography projection system from the object plane 300 to the image plane 400. The chief ray angle at the Object is denoted with y. The first mirror in the light path is identified by S1, the second mirror in the light path by S2, the third mirror in the light path by S3, the fourth mirror in the light path by S4, the fifth mirror in the light path by S5, the sixth mirror in the light path by S6, the seventh mirror in the light path by S7, and the eighth mirror in the light path by S8. In the embodiment shown, an intermediate image Z is provided in the light path between the sixth mirror (S6) and the seventh mirror (S7).

FIG. 4a.1 is a meridional section spanned by the y- and z- direction of a x-, y-, z-coordinate system showing only the used areas of the eight mirrors S1, S2, S3, S4, S5, S6, S7 and S8, the light path 10000, the optical axis HA as well as the image plane 400. FIG. 4a.2 is also a meridional section identical to FIG. 4a.1 but showing also the volume claim B1, B2, B3, B4, B5, B6, B7, B8 associated to each mirror or used area.

As may be seen from FIG. 4a.1, the first mirror S1 in the light path is a concave mirror and the second mirror S2 in the light path is also a concave mirror. The stop B is situated on or in proximity to the second mirror S2. The image-side numerical aperture is 0.4. The entire mirror surface of the particular mirror is not shown in FIG. 4a.1, but rather solely its used areas, on which the light which passes through the objective or the projection system from the object plane to the image plane is incident. In FIG. 4a.1 the y- and z-direction of a x-, y-, z-coordinate system in the central field point of the field to be illuminated in the object plane 300 is shown. FIG. 4a.1 shows the projection system in a meridional plane defined by the y-direction and the z-direction. The meridional plane comprises the optical axis HA. As may be seen clearly from FIG. 4a.1, the individual mirror segments or used areas of the mirrors S1, S2, S3, S4, S5, S6, S7, S8 are each freely accessible from the top or from the bottom in a direction parallel to the y-axis and thus an axis of symmetry of the projection system. It is therefore not necessary to engage in to the beam path which passes through the objective from the object plane 300 to the image plane 400 in order to mount the mirror segments. The optical axis of the projection objective, around which the individual mirror surfaces are rotationally symmetric, is identified by HA.

Furthermore, the individual mirror segments have a sufficient volume claim or rear installation space. This is shown in FIG. 4a.2. FIG. 4a.2 shows the eight mirrors, the light path, the optical axis HA as well as the image plane. FIG. 4a.2 is also a meridional section identical to FIG. 4a.1 but showing also the volume claim associated to each mirror or used area identified for the particular mirrors S1, S2, S3, S4, S5, S6, S7 and S8 by B1, B2, B3, B4, B5, B6, B7, and B8. According to the present invention, depth T of the volume claim refers to the extension of the volume claim from a central point of aused area of a mirror along the optical axis HA. The central point of the used area is the point of incidence AUF of the chief ray CR associated to the central field point of the object field in the object plane as shown in FIG. 2 onto the used area of a particular mirror. This is shown in particular for the mirrors S8, S4 and S1 in FIG. 4a.2. Furthermore, it may be seen in this exemplary embodiment that the volume claims or installation spaces of the different mirrors do not penetrate one another.

In the embodiment shown in FIG. 4a.1 and 4a.2, the highest angles of incidence occur on the third mirror S3 and the sixth mirror S6. In order to ensure sufficient projecting quality, the object in the object plane 300 is advantageously projected to the image in the image plane 400 by the microlithography projection system shown in FIG. 4a.1 and 4a.2 with the aid of polarized, preferably s-polarized light.

FIG. 4b shows the distortion of the chief ray over the field (in scan direction) for the exemplary embodiment 1 as shown in FIG. 4a.1 and 4a.2. As may be seen therefrom, the chief ray distortion is in the range of ±0.2 nm as a function of the field height. The distortion curve has the shape of a polynomial of an order >3 and is therefore corrected out very well over the field.

The optical data in Code V-format of the microlithography projection objective shown in FIG. 4a.1-4a.2 (exemplary embodiment 1) is specified in Table 2. The following identifications are used:

| Object: | Object plane: |
|---|---|
| Mirror 1: | mirror S1 |
| Stop: | stop |
| Mirror 2: | mirror S2 |
| Mirror 3: | mirror S3 |
| Mirror 4: | mirror S4 |
| Mirror 5: | mirror S5 |
| Mirror 6: | mirror S6 |
| Mirror 7: | mirror S7 |
| Mirror 8: | mirror S8 |
| Radius: | the radius of curvature of the particular mirror surface |
| Image: | image plane |

TABLE 2

| Surface | Radius | Thickness | Mode |
|---|---|---|---|
| Object | INFINITY | 565.355 | |
| Mirror 1 | −1778.723 | −364.418 | REFL |
| STOP | INFINITY | 0.000 | |
| Mirror 2 | 1663.986 | 514.418 | REFL |
| Mirror 3 | 423.681 | −293.414 | REFL |
| Mirror 4 | 924.220 | 977.627 | REFL |
| Mirror 5 | −957.770 | −297.131 | REFL |
| Mirror 6 | −769.616 | 357.562 | REFL |
| Mirror 7 | 365.867 | −257.562 | REFL |
| Mirror 8 | 328.776 | 297.562 | REFL |
| Image | INFINITY | 0.000 | |

| Surface | K | A | B | C |
|---|---|---|---|---|
| Mirror 1 | 0.00000E+00 | 1.29103E−09 | −1.17195E−14 | 1.59214E−19 |
| Mirror 2 | 0.00000E+00 | −4.73168E−10 | −8.15349E−15 | −1.90399E−19 |
| Mirror 3 | 0.00000E+00 | −3.18342E−10 | 6.62888E−15 | −3.61643E−20 |
| Mirror 4 | 0.00000E+00 | −2.11339E−11 | 7.30043E−17 | −5.46540E−23 |
| Mirror 5 | 0.00000E+00 | 2.86492E−10 | 4.04790E−16 | 8.19453E−22 |
| Mirror 6 | 0.00000E+00 | 5.82229E−09 | −3.76736E−14 | 1.52065E−19 |
| Mirror 7 | 0.00000E+00 | 1.11205E−08 | 8.65968E−13 | −1.16243E−18 |
| Mirror 8 | 0.00000E+00 | 2.61199E−10 | 3.24037E−15 | 3.28108E−20 |

| Surface | D | E | F | G |
|---|---|---|---|---|
| Mirror 1 | −2.14963E−24 | 2.30652E−29 | −1.67655E−34 | 0.00000E+00 |
| Mirror 2 | −4.27980E−25 | −9.10677E−28 | 2.63589E−32 | 0.00000E+00 |
| Mirror 3 | 5.12580E−25 | −3.34841E−30 | −6.40882E−35 | 0.00000E+00 |
| Mirror 4 | 2.14238E−28 | −2.85414E−34 | 3.40070E−40 | 0.00000E+00 |
| Mirror 5 | −1.06603E−27 | 7.59860E−33 | −1.77830E−39 | 0.00000E+00 |
| Mirror 6 | 1.45732E−24 | −2.20764E−29 | 6.16133E−35 | 0.00000E+00 |
| Mirror 7 | −1.19271E−21 | 2.74291E−25 | −5.41673E−29 | 0.00000E+00 |
| Mirror 8 | 3.68850E−25 | 1.14496E−30 | 8.72740E−35 | 0.00000E+00 |

The conical constant K and the aspheric coefficients A,B,C,D,E,F,G for the particular mirrors may be taken from the lower part of Table 2.

As may be seen from Table 2, the radii of curvature of all mirrors are less than 1800 mm.

FIGS. 5a and 5b show a second exemplary embodiment according to the present invention. FIG. 5a shows the arrangement of the individual used areas of a further embodinment of a 8-mirror projection system according to the present invention. FIG. 5a is a section in a meridonal plane defined by the y- and z-direction of a x-, y-, z-coordinate system in the object plane.

Identical components as in FIG. 4a.1 and 4a.2 are provided with the same reference numbers. The system shown in FIG. 5a has a high image side numerical aperture of 0.5. At a field height of 1 mm, the distortion of the chief ray over the field as shown in FIG. 5b results. As in the system shown in FIG. 4a.1 and 4a.2 in the system shown in FIG. 5a each of the used areas of the eight mirrors is freely accessible form at least the top or the bottom in a direction parallel to an axis of symmetry, e.g. an direction parallel to the y-direction. The optical data in code V-format of the system shown in FIG. 5a may be taken from Table 3. The following identifications are used:

| Object: | Object plane: |
|---|---|
| Mirror 1: | mirror S1 |
| Stop: | stop |
| Mirror 2: | mirror S2 |
| Mirror 3: | mirror S3 |
| Mirror 4: | mirror S4 |
| Mirror 5: | mirror S5 |
| Mirror 6: | mirror S6 |
| Mirror 7: | mirror S7 |
| Mirror 8: | mirror S8 |
| Radius: | the radius of curvature of the particular mirror surface |
| Image: | image plane |

TABLE 3

| Surface | Radius | Thickness | Mode |
|---|---|---|---|
| Object | INFINITY | 826.995 | |
| Mirror 1 | −3335.738 | −626.995 | REFL |
| STOP | INFINITY | 0.000 | |
| Mirror 2 | 1559.277 | 740.156 | REFL |
| Mirror 3 | 464.241 | −350.186 | REFL |
| Mirror 4 | 1163.457 | 872.948 | REFL |
| Mirror 5 | −918.918 | −315.086 | REFL |
| Mirror 6 | −618.093 | 370.360 | REFL |
| Mirror 7 | 541.748 | −270.360 | REFL |
| Mirror 8 | 358.933 | 310.360 | REFL |
| Image | INFINITY | 0.000 | |

| Surface | K | A | B | C |
|---|---|---|---|---|
| Mirror 1 | −1.28943E+02 | 0.00000E+00 | 1.31498E−15 | −1.17269E−20 |
| Mirror 2 | −7.77075E−01 | 0.00000E+00 | −4.23667E−16 | −2.47857E−21 |
| Mirror 3 | −4.79436E−01 | 0.00000E+00 | 1.43905E−14 | 3.05673E−20 |
| Mirror 4 | −9.53173E−01 | 0.00000E+00 | 9.94570E−17 | 2.00025E−22 |
| Mirror 5 | −9.89222E−01 | 0.00000E+00 | −1.53677E−16 | 1.13744E−21 |
| Mirror 6 | −7.06268E+00 | 0.00000E+00 | 7.88038E−15 | −3.24571E−20 |
| Mirror 7 | 9.97360E+00 | 0.00000E+00 | 1.15942E−13 | −1.17580E−18 |
| Mirror 8 | 9.24132E−02 | 0.00000E+00 | 7.02167E−16 | 9.00227E−21 |

| Surface | D | E | F | G |
|---|---|---|---|---|
| Mirror 1 | 1.35058E−25 | −1.60197E−30 | 1.33765E−35 | −5.52982E−41 |
| Mirror 2 | −5.14064E−26 | 7.71789E−31 | −3.78453E−35 | 2.70222E−40 |
| Mirror 3 | 3.53894E−25 | 1.14830E−29 | −1.21773E−34 | 1.55602E−39 |
| Mirror 4 | −3.88408E−28 | 8.70914E−34 | −1.07117E−39 | 7.13293E−46 |
| Mirror 5 | −2.41272E−27 | 4.25815E−33 | −3.53800E−39 | 3.17601E−45 |
| Mirror 6 | 8.03573E−25 | −2.77028E−29 | 3.27165E−34 | −1.32749E−39 |
| Mirror 7 | −2.00359E−22 | −7.11805E−27 | 2.25524E−30 | −2.90850E−34 |
| Mirror 8 | 2.46219E−26 | 2.80833E−30 | −3.55647E−35 | 4.64584E−40 |

Because of the greater image-side aperture in the exemplary embodiment shown in FIGS. 5a and 5b than in the exemplary embodiment shown in FIGS. 4a.1, 4a.2 and 4b, a higher resolution is achieved. From the lower part of table 3 the conical constant K as well as the aspheric coefficients A, B, C, D, E, F, G can be taken.

The exemplary embodiment 3 of the invention is shown in FIGS. 6a and 6b. FIG. 6a shows a section of the projection system in a meridonal plane comprising the y- and the z-direction of a x-,y-,z-coordinate system defined in the object plane FIG. 6b shows the distortion of the chief ray over the field in scan direction. The exemplary embodiment essentially corresponds to the exemplary embodiment 2, but the scanning slit width in the exemplary embodiment 3 is increased by 1 mm to a total of 2 mm in relation to exemplary embodiment 2. The dose control may be improved by the greater length of the scanning slit, i.e., the unavoidable dose oscillations in the image plane because of the pulsed operation of the light source are reduced by the larger scanning slit.

Identical components as in FIGS. 4a.1, 4a.2, 4b, 5a and 5b are provided with the same reference numbers in FIGS. 6a and 6b.

The following Table 4 gives the optical data in code V-format for the system shown in FIGS. 6a and 6b. The following identifications are used:

| Object: | Object plane: |
|---|---|
| Mirror 1: | mirror S1 |
| Stop: | stop |
| Mirror 2: | mirror S2 |
| Mirror 3: | mirror S3 |
| Mirror 4: | mirror S4 |
| Mirror 5: | mirror S5 |
| Mirror 6: | mirror S6 |
| Mirror 7: | mirror S7 |
| Mirror 8: | mirror S8 |
| Radius: | the radius of curvature of the particular mirror surface |
| Image: | image plane |

TABLE 4

| Surface | Radius | Thickness | Mode |
|---|---|---|---|
| Object | INFINITY | 831.751 | |
| Mirror 1 | −3325.247 | −631.751 | REFL |
| STOP | INFINITY | 0.000 | |
| Mirror 2 | 1559.577 | 741.751 | REFL |
| Mirror 3 | 464.776 | −350.165 | REFL |
| Mirror 4 | 1163.439 | 880.304 | REFL |
| Mirror 5 | −919.894 | −314.717 | REFL |
| Mirror 6 | −622.166 | 370.326 | REFL |
| Mirror 7 | 537.195 | −270.326 | REFL |
| Mirror 8 | 359.029 | 310.327 | REFL |
| Image | INFINITY | 0.000 | |

| Surface | K | A | B | C |
|---|---|---|---|---|
| Mirror 1 | −1.27767E+02 | 0.00000E+00 | 1.29304E−15 | −1.12692E−20 |
| Mirror 2 | −7.21458E−01 | 0.00000E+00 | −4.09238E−16 | −2.25587E−21 |
| Mirror 3 | −4.92550E−01 | 0.00000E+00 | 1.42789E−14 | 3.28843E−20 |
| Mirror 4 | −9.62647E−01 | 0.00000E+00 | 9.92603E−17 | 1.98712E−22 |
| Mirror 5 | −9.90285E−01 | 0.00000E+00 | −1.54270E−16 | 1.13725E−21 |
| Mirror 6 | −7.17760E+00 | 0.00000E+00 | 7.78520E−15 | −3.41448E−20 |
| Mirror 7 | 9.62044E+00 | 0.00000E+00 | 1.22297E−13 | −1.02551E−18 |
| Mirror 8 | 9.26534E−02 | 0.00000E+00 | 6.98452E−16 | 9.06361E−21 |

| Surface | 0 | E | F | G |
|---|---|---|---|---|
| Mirror 1 | 1.20111E−25 | −1.27289E−30 | 9.47793E−36 | −3.62659E−41 |
| Mirror 2 | −5.67389E−26 | 1.14419E−30 | −4.58322E−35 | 3.60372E−40 |
| Mirror 3 | 1.52698E−25 | 1.53109E−29 | −1.66222E−34 | 1.68198E−39 |
| Mirror 4 | −3.92553E−28 | 8.72925E−34 | −1.06787E−39 | 7.01073E−46 |
| Mirror 5 | −2.41241E−27 | 4.24646E−33 | −3.55381E−39 | 3.15384E−45 |
| Mirror 6 | 8.41221E−25 | −2.71375E−29 | 3.10604E−34 | −1.23104E−39 |
| Mirror 7 | −1.74283E−22 | −1.21847E−26 | 2.88967E−30 | −3.14174E−34 |
| Mirror 8 | 1.96195E−26 | 2.92124E−30 | −3.71944E−35 | 4.71893E−40 |

The lower part of table 4 describes the conical constant K and the aspheric coefficients A, B, C, D, E, F and G.

FIG. 7 shows a projection exposure apparatus for microlithography having a projection objective 1200 according to the present invention having eight used areas 1200 or mirrors as shown in FIG. 4a.1-4b.

In the embodiment shown in FIG. 7, the projection exposure apparatus 1000 comprises a polarized radiation source 1204.1, which emits polarized light, as a light source.

The light of the polarized radiation source 1204.1 is guided with the aid of an illumination system 1202 into the object plane of the projection system of the projection exposure apparatus and illuminates a field in the object plane 1203 of the projection system using polarized light. The field in the object plane 1203 has a shape as shown in FIG. 2.

The illumination system 1202 may be implemented as described, for example, in WO 2005/015314 having the title “illumination system, in particular for EUV lithography”.

According to the present invention, the illumination system preferably illuminates a field in the object plane of the projection objective or projection system using polarized light.

The collector 1206 is a grazing-incidence collector as is known, for example, from WO02/065482A2. After the collector 1206 in the light path, a grid spectral filter 1207 is situated, which, together with the stop 1209 in proximity to the intermediate image ZL of the light source 1204.1, is used for the purpose of filtering out undesired radiation having wavelengths not equal to the used wavelength of 13.5 nm, for example, and preventing it from entering into the illumination system behind the stop.

A first optical raster element 1210 having 122 first raster elements, for example, is situated behind the stop. The first raster elements provides for secondary light sources in a plane 1230. A second optical element 1212 having second raster elements, which, together with the optical elements 1232, 1233, and 1234 following the second raster element in the light path, images the field into a field plane which is coincident with the object plane 1203 of the projection objective 1200. The second optical element having second raster elements is situated in proximity to or in a plane 1230, in which the secondary light sources are provided. For example, a structured mask 1205, the reticle, is situated in the object plane 1203 of the projection system, which is imaged with the aid of the projection system 1200 using polarized light intoa image plane 1214 of the projection system 1200. A substrate having a light-sensitive layer 1242 is situated in the image plane 1214. The substrate having a light-sensitive layer may be structured through subsequent exposure and development processes, resulting in a microelectronic component, for example, such as a wafer having multiple electrical circuits. In the field plane the y- and z-direction of a x-, y-, z- coordinate system with its origin in the central field point is shown.

As is apparent from FIG. 7 and 8 for lithography with wavelengths <100 nm, especially with wavelengths of e.g. 13.5 nm for EUV lithography not only the projection system is a catoptric optical system but also the illumination system is a catoptric optical system. In a catoptric optical system reflective optical components. such as e.g. mirrors are guiding the light e.g. from an object plane to an image plane. In a catoptric illumination system the optical components of the illumination system are reflective. In such a system the optical elements 1232, 1233, 1234 are mirrors, the first optical element 1210 having first raster elements is a first optical element having a plurality of first mirror facets as first raster elements and the second optical element 1212 having second raster elements is a second optical element having second mirror facets.

The microlithography projection system 1200 is preferably a projection system according to the present invention, most preferably a catoptric projection system having eight mirrors, wherein the first mirror in the light path from the object plane to the image plane is a concave mirror and the second mirror is a concave mirror.

Furthermore the microlithography projection system has preferably an unobscured exit pupil. The projection system 1200 illustrated in FIG. 7 is therefore implemented as shown in FIG. 4a.1-4b, i.e., it comprises a total of 8 mirrors, a first mirror S1, a second mirror S2, a third mirror S3, a fourth mirror S4, a fifth mirror S5, a sixth mirror S6, a seventh mirror S7, and an eighth mirror S8. The first mirror S1 and the second mirror S2 in the light path from the object plane 1203 to the image plane 1214 of the projection system being implemented as concave mirrors. Reference is made to FIG. 4a.1-4b with regard to the projection system and the precise optical data.

In an alternative embodiment of the present invention, the light source 1204.2 emits unpolarized light having wavelengths e.g. in the EUV range from 1-20 nm. A projection exposure apparatus 2000 having a light source of this type being illustrated in FIG. 8. The illumination system 2200 comprises a collector 2206, which is implemented in the present case as a normal-incidence collector. The normal-incidence collector 2206 collects the unpolarized light of the light source 1204.2 and conducts it to a first optical element 2210 having first raster elements. The first raster elements of the first optical element form secondary light sources in a plane 2230. A second optical element 2212 having second optical raster elements is situated in or in proximity to this plane 2230. Together with the mirrors 2232, 2233, 2234 following the second optical element 2212 having second raster elements in the light path, a field in the object plane 2203 of the projection objective 2200 is imaged.

In order that polarized light reaches the projection system 2200, an element is provided in the beam path from the light source up to the first mirror S1 in the projection system which sets the polarization state. The element which sets the polarization state in the illumination system is preferably still situated in the illumination system. By using an element which sets the polarization state in the illumination system 2202, it is not only possible to use light sources which do not generate polarized light (e.g., laser-plasma sources or discharge sources), but rather also to adapt the polarization state to the lithographic requirements through such an element. As in FIG. 7 the illumination system is a catoptric illumination system comprising reflective optical components, such as mirrors.

The grazing-incidence mirror 2234 provides for the setting of the polarization state in the exemplary embodiment of a projection exposure apparatus shown in FIG. 8. The grazing-incidence mirror 2234 is therefore also denoted as polarizer or polarizing element. Alternatively, instead of a grazing-incidence mirror 2234, a wire grid (not shown), may be used as an element for setting the polarization state. With a wire grid as the element for setting the polarization state, the s-polarized light is reflected on the element in the direction of the object plane 2203, in which a reticle of a mask 2205 is situated, and the p-polarized light passes through the element. The polarized light reflected from the reticle 2205 is imaged using the projection system 2200 according to the present invention into the image plane 2214 of the projection system, in which a substrate comprising a light-sensitive layer is situated. The projection objective is a projection objective as shown in FIG. 4a.1-4b. All optical data may be taken from the description of FIG. 4a.1-4b. Furthermore, the reference numbers are identical to those in FIG. 4a.1-4b.

Of course, one skilled in the art may replace the special projection objective according to FIG. 4a.1-4b, which is shown in FIGS. 7 and 8, without deviating from the idea of the present invention, namely using polarized light in a projection exposure apparatus for lithography with wavelengths in the EUV region.

In particular, projection systems according to FIGS. 5a and 6a of the present application may also be used.

Other projection systems are also conceivable for lithography with polarized light having wavelengths in the EUV region, such as 8-mirror projection systems as disclosed e.g. in U.S. Pat. No. 6,710.917, a 6-mirror projection system as disclosed e.g. in U.S. Pat. No. 6,660.552, or a 4-mirror projection system as disclosed e.g. in U.S. Pat. No. 6,577,443.

The disclosure content of the aforementioned US-patents is enclosed in their entirety in this application.

The present invention specifies for the first time a microlithography projection system in which the radii of the individual mirrors have absolute values less than 5000 mm. Furthermore, the microlithography projection systems according to the present invention are distinguished in that the optical power is distributed uniformly on the first two concave mirrors in the light path from an object plane to an image plane.

Furthermore, the present invention specifies for the first time a microlithography projection exposure apparatus for wavelengths in the EUV range, i.e., in particular between 1 nm and 20 nm, which is distinguished by very small image errors at high apertures of the projection objective in comparison to a projection exposure apparatus known from the state of the art. This is among other things due to the fact that polarized light of a defined polarization state is provided for the first time by the illumination system in the EUV-wavelength-range

Moreover, a method for producing microelectronic components using a projection exposure apparatus is specified. In this method, a structured mask (reticle) is situated in the object plane of the projection exposure apparatus and imaged with the aid of the projection system on a light-sensitive layer situated in the image plane of the projection system. The exposed light-sensitive layer is developed, resulting in a part of a microelectronic component or the microelectronic component itself. The production of a microelectronic component using a projection exposure facility is well-known to those skilled in the art.

1. A microlithography projection exposure apparatus comprising:
an illumination system configured to illuminate a field in an object plane using light of a defined polarization state, and
a projection system, having at least a first mirror a second mirror, a third mirror, and a fourth mirror,
wherein:
the projection system is configured to project the field in the object plane into an image in an image plane,
the light of the defined polarized state can pass through the projection system from the object plane to the image plane,
the projection system has an image-side numerical aperture NA of at least 0.3, and
the defined polarization state is selected in such way that essentially s-polarized light is provided in the image plane.

2. The projection exposure apparatus according to claim 1, wherein the defined polarization state is selected in such a way that the transmission of the projection system is a maximum.

3. The projection exposure apparatus according to claim 1, wherein the defined polarization state is selected in such way that essentially s-polarized light is provided on the mirror of the projection system having the greatest angle of incidence of a chief ray, which originates from a central field point of a field in the object plane and is incident on the mirror.

4. (canceled)

5. The projection exposure apparatus according to claim 1, wherein the illumination system has a light source which emits polarized light.

6. The projection exposure apparatus according to claim 1, wherein the illumination system has a light source which emits unpolarized light.

7. The projection exposure apparatus according to claim 1, wherein the illumination system comprises an element configured to provide the defined polarization state.

8. The projection exposure apparatus according to claim 1, wherein a chief ray angle of a central field point of the field to be illuminated in the object plane is <10°.

9. The projection exposure apparatus according to claim 1, wherein a beam bundle comprises a chief ray of a central field point of the field to be illuminated in the object plane and wherein the chief ray is incident at an angle greater than 20° on at least one of the mirrors of the projection system.

10. The projection exposure apparatus according to claim 1, wherein the projection system comprises in a light path from the object plane to the image plane at least a first mirror, a second mirror, a third mirror, a fourth mirror, a fifth mirror, and a sixth mirror.

11. The projection exposure apparatus according to claim 1, wherein the projection system comprises at least in a light path from the object plane to the image plane a first mirror and a second mirror, wherein at least one of the first and the second mirror is a concave mirror.

12. The projection exposure apparatus according to claim 11, wherein the first mirror of the projection system has a first radius (R1), the second mirror of the projection system has a second radius, (R2) and a ratio of the first radius to the second radius is in the range
$$- 6 < \frac{R 1}{R2} < - \frac{1}{6} .$$

13. The projection exposure apparatus according to claim 1, wherein the projection system comprises in a light path from the object plane to the image plane at least a first mirror, a second mirror, a third mirror, a fourth mirror, a fifth mirror, a sixth mirror, a seventh mirror, and a eighth mirror.

14. The projection exposure apparatus according to claim 1, wherein in a light path form the object plane to the image plane at least first, second, third, fourth, fifth, and sixth mirrors of the projection system are situated in centered arrangement to an optical axis;
each of these mirrors having a used area, on which the light beams which are guided through the projection system from the object plane to the image plane are incident;
and wherein first, second, third, fourth, fifth, and sixth mirrors each have a volume claim which, measured parallel to the optical axis starting from a central point of the used area of the respective mirror, has a depth, wherein the depth being greater than ⅓ of the value of the diameter of the mirror.

15. The projection exposure apparatus according to claim 1, wherein in a light path from the object plane to the image plane at least first, second, third, fourth, fifth, and sixth mirrors of the projection system are situated in centered arrangement to an optical axis;
each of the first, second, third, fourth, fifth and sixth mirrors of the projection system having a used area, on which the light beams which are guided through the projection system from the object plane to the image plane are incident;
and wherein the first, the second, the third, the fourth, the fifth, and the sixth mirror of the projection system each have a volume claim which, measured parallel to the optical axis starting from a central point of a used area of a respective mirror, has a depth being greater than 50 mm for each volume claim.

16. The projection exposure apparatus according to claim 14, wherein the volume claim of different mirrors are not penetrating one another.

17. The projection exposure apparatus according to claim 14, wherein all volume claims are extendable in a direction parallel to an axis of symmetry of the projection system, without intersecting the light path of the light propagating in the projection system from the object plane to the image plane.

18. The projection exposure apparatus according to claim 14, wherein all volume claims are extendable in a direction parallel to an axis of symmetry of the projection system, without intersecting any volume claim of the other mirrors of the projection system.

19. The projection exposure apparatus according to claim 1, wherein the projection system is a catoptric system.

20. The projection exposure apparatus according to claim 1, wherein the illumination system has at least a optical element and wherein all optical elements of the illumination system are reflective optical elements.

21. A microlithography projection system configured to project an object in an object plane into an image in an image plane, the microlithography projection system comprising:
a first mirror, a second mirror, a third mirror, a fourth mirror, a fifth mirror, a sixth mirror, a seventh mirror, and a eighth mirror, the first, second, third, fourth, fifth, sixth, seventh and eighth mirrors being situated in a light path from the object plane to the image plane,
wherein the projection system has an unobscured exit pupil and wherein the first, second, third, fourth, fifth, sixth, seventh, and eight mirrors each have a volume claim and wherein all volume claims are extendable in a direction parallel to an axis of symmetry of the projection system, without intersecting the light path of the light propagating in the projection system from the object side to the image side.

22. The microlithography projection system according to claim 21, wherein all volume claims are extendable in a direction parallel to an axis of symmetry of the projection system, without intersecting any volume claim of the other mirrors of the projection system.

23. A microlithography projection system configured to project an object in an object plane into an image in an image plane, the microlithography projection system comprising:
a first mirror, a second mirror, a third mirror, a fourth mirror, a fifth mirror, a sixth mirror, a seventh mirror, and a eighth mirror, the first, second, third, fourth, fifth, sixth, seventh and eighth mirrors being situated in a light path from the object plane to the image plane, wherein
the projection system has a unobscured exit pupil and
wherein the first, second, third, fourth, fifth, sixth, seventh, and eight mirrors each have a volume claim and wherein all volume claims are extendable in a direction parallel to an axis of symmetry of the projection system, without any volume claim of the other mirrors of the projection system.

24. A microlithography projection system configured to project an object in an object plane into an image in an image plane, the microlithography projection system comprising:
at least a first mirror, a second mirror, a third mirror, a fourth mirror, a fifth mirror, a sixth mirror, a seventh mirror, and a eighth mirror, which are the first, second, third, fourth, fifth, sixth, seventh and eighth mirrors being situated in a light path from the object plane to the image plane, wherein
at least one of the first and second mirrors is a concave mirror, and each of the mirrors of the projection system is assigned a radius and an absolute value of the radius of all non planar mirrors of the projection system is less than 5000 mm.

25. The microlithography projection system according to claim 21, wherein at least the first mirror or at least the second mirror is a planar mirror.

26. The microlithography projection system according to claim 21, wherein at least the first mirror is a concave mirror and the second mirror is a planar mirror or the first mirror is a planar mirror and at least the second mirror is a concave mirror.

27. The microlithography projection system according to claim 21, wherein the first mirror in the light path from the object plane to the image plane has a first radius (R1) and the second mirror in the light path from the object plane to the image plane has a second radius (R2) and the ratio of the first radius to the second radius is in the range of
$$- 6 < \frac{R 1}{R2} < - \frac{1}{6} .$$

28. The microlithography projection system according to claim 21, wherein the image-side aperture NA is ≧0.3.

29. The microlithography projection system according to claim 21, wherein at least the first, the second, the third, the fourth, the fifth, and the sixth mirror of the projection system are situated in centered arrangement to an optical axis;
each of these mirrors having a used area, on which the light beams which are guided through the projection system in a light path are incident;
and the first, the second, the third, the fourth, the fifth, and the sixth mirrors each have a volume claim which, measured parallel to the optical axis starting from a central point in a used area of a respective mirror has a depth being greater than ⅓ of the value of the diameter of the mirror and the volume claims of different mirrors are not penetrating one another.

30. The microlithography projection system according to claim 29 wherein the seventh mirror is situated centered to the optical axis and the seventh mirror has a volume claim which, measured parallel to the optical axis starting from a central point in a used area of the respective mirror has a depth greater than ⅓ of the value of the diameter of the seventh mirror.

31. The microlithography projection system according to claim 29 wherein the eighth mirror is situated centered to the optical axis and the eighth mirror has a volume claim which, measured parallel to the optical axis starting from a central point in a used area of the respective mirror has a depth greater than ⅓ of the value of the diameter of the eighth mirror.

32. The microlithography projection system according to claim 21,
wherein at least the first, the second, the third, the fourth, the fifth, and the sixth mirror of the projection system are situated in centered arrangement to an optical axis;
each of these mirrors having a used area, on which the light beams which are guided through the projection system in a light path (10000) are incident;
and the first, the second, the third, the fourth, the fifth, and the sixth mirrors each have a volume claim which, measured parallel to the optical axis starting from a central point in a used area of the respective mirror, has a depth being greater than 50 mm.

33. The microlithography projection system according to claim 32, wherein the seventh mirror is situated centered to the optical axis and the seventh mirror has a volume claim which, measured parallel to the optical axis starting from a central point in a used area has a depth being greater than 50 mm.

34. The microlithography projection system according to claim 32, wherein the eighth mirror is situated centered to the optical axis and the eighth mirror has a volume claim which, measured parallel to the optical axis starting from a central point in a used area has a depth being greater than 50 mm.

35. A method, comprising producing microelectronic components using a projection exposure apparatus according to claim 1, wherein a structured mask in the object plane is projected onto a light-sensitive layer in the image plane and, after exposure of the light-sensitive layer, the light sensitive layer is developed, resulting in a microelectronic component or part of a microelectronic component.
